(19) United States
(12) Patent Application Publication
(10) Pub. No.: US 2025/0161951 A1
(43) Pub. Date: May 22, 2025

(54) AGITATING WET BALL MILLING APPARATUS

(71) Applicant: Shenzhen Keli Nano Engineering Equipment Co., Ltd., Shenzhen (CN)

(72) Inventor: Bo CHEN, Shenzhen (CN)

(73) Assignee: Shenzhen Keli Nano Engineering Equipment Co., Ltd., Shenzhen (CN)

(21) Appl. No.: 19/026,831

(22) Filed: Jan. 17, 2025

Related U.S. Application Data
(63) Continuation of application No. PCT/CN2023/110537, filed on Aug. 28, 2023.

(30) Foreign Application Priority Data
Dec. 7, 2022 (CN) 202211550692.8

(51) Int. Cl. B02C 17/16; B02C 17/18

(52) U.S. Cl. CPC B02C 17/161; B02C 17/1815

(57) ABSTRACT

A agitating wet ball milling apparatus, by connecting one end of the second separation chamber in the length direction with the first separation chamber to form a second separation channel, increases the separation flow rate and reduces the pressure in the first separation chamber. During separation, the mass of the grinding balls is much greater than the diameter and mass of the material. When a small amount of grinding balls enter the first separation chamber, they move to the bottom of the first separation chamber under the action of gravity. The second separation chamber keeps the grinding balls away from the discharge port and also reduces the number of grinding balls in the first separation chamber that enter the second separation chamber for discharge. This ensures the separation flow rate while reducing the phenomenon of ball leakage and improving the grinding efficiency.

### CROSS-REFERENCE TO RELATED APPLICATIONS

The application claims priority to Chinese patent application No. 202211550692.8, filed on Dec. 7, 2022, the entire contents of which are incorporated herein by reference.

### TECHNICAL FIELD

The present invention relates to the technical field of agitating milling, and in particular to a agitating wet ball milling apparatus.

### BACKGROUND

Existing wet grinding apparatuses, e.g., a ball mill, not only require a dispersing mechanism providing power for grinding and materials, but also require a separation apparatus separating satisfactory materials and mill balls. That is, the existing wet grinding apparatus not only needs to grind materials into a desired diameter, but also needs to separate the ground materials from mill balls, and separate large-diameter materials from satisfactory materials, which thus prevents mill balls from entering into discharging channels during the discharging process, leading to contamination of the discharged materials after being ground. Meanwhile, the grinding efficiency will be affected due to reduced grinding frequency.

### SUMMARY

The technical problem to be mainly solved in the present invention is to provide a agitating wet ball milling apparatus. The agitating wet ball milling apparatus improves the grinding efficiency via improving flow circulation modes during separation.

To solve the aforesaid technical problem, the present invention provides a agitating wet ball milling apparatus, including a grinding cylinder and a dispersing mechanism arranged in the grinding cylinder; the dispersing mechanism is connected to a driving assembly via a rotating shaft; the grinding cylinder is provided with a feeding port and a discharging port; the discharging port is provided with a separation apparatus. The separation apparatus includes a first separator provided with a cavity and a second separator located in the cavity of the first separator; a first separation cavity is disposed between the first separator and the second separator; the second separator is provided with a second separation cavity in communication with a discharging port; the second separation cavity is in communication with the first separation cavity in a radial direction and in an axial direction, respectively to form a first separation channel and a second separation channel; a cover for closing the cavity of the first separator in an axial direction and a first separation gap in communication with an inside and an outside of the first separator are disposed at an end portion and in a radial direction of the first separator, respectively; a third separation gap in communication with the first separation cavity and the second separation cavity is disposed between the cover and an end portion of the second separator; a through hole and a second separation gap are disposed at the end portion and in a radial direction of the second separator, respectively; the second separation gap is in communication with the second separation cavity and the first separation cavity; the through hole is in communication with the second separation cavity and first separation cavity via the third separation gap; the second separation channel includes the third separation gap connected to the first separation gap and the second separation gap, and the third separation gap is in radial communication with the second separation cavity.

Further, the second separation channel includes the second separation cavity in communication with the first separation gap and the third separation gap.

Further, the second separation channel is provided with a ball tripping mechanism; the ball tripping mechanism includes a first interceptor extending to the first separator in a radial direction and a second interceptor extending to the second separator in a radial direction; and an interception channel is formed between the first interceptor and the second interceptor in a staggered manner.

Further, the first interceptor is close to one side of the discharging port, and the second interceptor is located outside the first interceptor.

Further, the separation apparatus is further provided with a mill-ball sorting mechanism.

Further, the mill-ball sorting mechanism includes a mill-ball sorting cavity that is in communication with the first separation cavity and is provided with a ball discharging hole and a switch for controlling the ball discharging hole.

Further, a bottom of the mill-ball sorting cavity is lower than the first separation cavity; the bottom of the mill-ball sorting cavity is inclined to a direction of the discharging port.

Further, the first separation cavity is internally provided with an ultrasonic vibration module.

Further, the ultrasonic vibration module includes a vibrating rod and an ultrasonic generator generating vibration towards the vibrating rod or around the vibrating rod.

Further, the separation apparatus further includes a water-cooled tube for cooling the ultrasonic vibration module.

Further, a sealing gasket is disposed between the cover and the first separator.

Further, the end portion of the second separator gradually increases in a radial direction.

Further, the end portion of the second separation cavity is a trumpet-shaped structure in a radial direction.

Further, the separator is provided with a water-cooling mechanism.

Further, the water-cooling mechanism comprises a plurality of coolant tubes to form a tubular cooling tube body; both ends of the cooling tube body are fixed with fixed plates and a flange, respectively; a water groove in communication with the coolant tubes is disposed on the fixed plates and the flange, respectively; a cooling separation gap is disposed between two adjacent coolant tubes; and where the flange is provided with a water inlet and a water outlet that are in communication with the water groove, respectively.

Further, the cooling separation gap is greater than a separation gap on the second separator.

Further, the coolant tubes are arranged in parallel.

Further, the coolant tubes are tabular.

Further, the water inlet and the water outlet are located at the flange in a maximum position of a straight-line distance.

Further, the water-cooling mechanism includes a plurality of coolant tubes to form a tubular cooling tube body; adjacent coolant tubes on one end of the cooling tube body are communicated in sequence; another end thereof is fixed with the flange; the flange is provided with a water groove in communication with the coolant tubes; a cooling separation gap is disposed between two adjacent coolant tubes; and where the flange is provided with a water inlet and a water outlet that are in communication with the water groove, respectively.

Further, the water-cooling mechanism includes a coolant tube to form a water loop; both ends of the coolant tube are fixed with fixed a flange, respectively; the flange is provided with a water inlet and a water outlet that are in communication with the coolant tube.

Further, the coolant tube is a spiral structure; and a cooling separation gap is disposed between adjacent spirals.

Further, the separator is a mesh-screen separator; the mesh-screen separator is provided with a separation cavity in communication with a separation outlet; the ultrasonic generator and the water-cooling mechanism are disposed in the separation cavity.

Further, the water-cooling mechanism is located between the ultrasonic generator and the separator.

Further, the ultrasound field separation apparatus further includes a controller for controlling the ultrasonic generator to work.

### Advantageous Effects

According to the agitating wet ball milling apparatus of the present invention, the second separator has a surface area of less than that of the first separator such that pressure in the first separation cavity increases during separation and the separation flow rate decreases to cause low separation efficiency. Moreover, the increase of pressure in the first separation cavity easily results in a risk of separation failure of the second separator. One end of the second separation cavity in a radial direction, i.e., in a length direction, is in communication with the first separation cavity to form the second separation channel to increase the separation flow rate, which may reduce pressure in the first separation cavity. In the meantime, mass of the mill ball is much greater than the diameter and mass of materials during separation; even a small number of mill balls enter the first separation cavity, these mill balls basically move to the bottom of the first separation cavity due to their own action of gravity. Moreover, the second separation cavity enables the mill balls to be far away from the discharging port, which also can block mill balls possibly existing in the first separation cavity entering into the second separation cavity to be discharged. Therefore, the present invention can not only ensure the separation flow rate, but also can reduce the phenomenon of ball leakage, thereby improving the grinding efficiency.

### BRIEF DESCRIPTION OF DRAWINGS

To specify the embodiments of the present invention or the technical solution in the prior art more clearly, the accompanying drawings required in the description of the embodiments or prior art will be introduced briefly. Obviously, the depicted accompanying drawings merely show some examples of the present invention and thus, shall be not construed as limiting the scope. Those skilled in the art can further obtain other correlated drawings according to these accompanying drawings without any inventive effort.

FIG. 1 is a schematic diagram showing a sectional structure of an embodiment of a agitating wet ball milling apparatus along an axial direction;

FIG. 2 is a schematic diagram showing a structure of a separation apparatus embodiment;

FIG. 3 is a schematic diagram showing a sectional structure of the separation apparatus embodiment along an axial direction;

FIG. 4 is a schematic diagram showing a structure of an ultrasound field separation apparatus embodiment;

FIG. 5 is a disassembly diagram showing a structure of an ultrasonic generator embodiment; and

FIG. 6 is a schematic diagram showing an enlarged structure in FIG. 5.

The purpose realization, functional features, and advantages of the present invention will be further specified in combination with the embodiments and with reference to the accompanying drawings.

### DETAILED DESCRIPTION OF THE EMBODIMENTS

Claims of the present invention will be further specified in combination with the detailed embodiments and with reference to the accompanying drawings below. Obviously, the described embodiments are merely a portion of the embodiments, but not all the embodiments in the present invention. Based on the embodiments of the present invention, all the other embodiments obtained by those skilled in the art without any inventive effort shall fall within the scope of protection of the present invention.

It needs to be understood that the orientations or positional relations indicated by all the directionally indicative terms such as “upper”, “lower”, “left”, “right”, “front”, and “rear” described in the embodiments of the present invention are based on the orientations or positional relations as shown in the accompanying drawings, or the conventional placement orientations or positional relations of the product of the present invention. These are merely to simply the description of the present invention, but are not to explicitly indicate or hint that the indicated devices, elements or components must have a specific orientation and specific orientation configuration, and thus, are not construed as limiting the present invention. These are merely used to interpret the relative positional relation, movement situation and the like among components as shown in the accompanying drawings; when a specific posture changes, the directional indication also possibly changes therewith.

In addition, the ordinal numerals in the present invention, such as “first” and “second” are merely for the purpose of distinguishing, but are not construed as indicating or hinting its relative importance or implying the number of the technical features indicated. The “first” and “second” features defined thereby may explicitly indicate or hint at least one of the technical features. In the description of the present invention, “a plurality of” means at least two, i.e., two or more, unless otherwise stipulated explicitly; “at least one” means one or more.

In the present invention, terms such as “mount”, “dispose”, “connect”, “fix”, and “rotary connection” should be understood in broad sense, unless otherwise stipulated and defined explicitly. For example, it may be relative fixation among components in positional relation, the presence of physical fixed connection, detachable connection, or may be integrated into an integral structure; it may be mechanical connection, and also electrical signal connection; it may be direct connection, and also indirect connection via a medium or a component; it may be internal communication between two components, and also interactive relationship between two components, unless otherwise defined in the description explicitly, i.e., the corresponding function or effect may not be achieved when it is interpreted in other means. Those skilled in the art may understand the specific meanings of the aforesaid terms in the present invention according to specific circumstances.

Controllers and control circuits (if any) involved in the present invention are conventional control technologies or units to those skilled in the art; for example, the control circuit of a controller may be achieved by those skilled in the art via prior art, e.g., simple programming. As for the software or program in coordination with hardware to achieve control results, if it is not specified in the description to denote the involved software or program control procedure, it falls within the prior art or conventional technologies to those skilled in the art. Power supply is also subjected to the prior art in the art. Moreover, the major technical point of the present invention lies in the improvement of a mechanical device. Hence, the specific circuit control relationship and electrical connection will be not described in detail here.

The disclosure of the present invention provides lots of different embodiments or examples to achieve different structures of the present invention. To simply the disclosure of the present invention, components and configuration of specific examples are described in the present invention. Certainly, these are only examples and not aimed at limiting the present invention. In addition, the present invention may repeatedly reference numerals and/or letters in different examples; such a repetition is for the purpose of simplification and clarification, but is not indicative of the relationship among the discussed each embodiment and/or configuration. Additionally, the present invention provides various examples of specific processes and materials, but those skilled in the art may realize the application of other processes and/or use of other materials.

Preferred embodiments of the present invention will be specified with reference to the accompanying drawings. It should be understood that detailed embodiments described herein are merely used to specify and interpret the present invention, but are not construed as limiting the present invention.

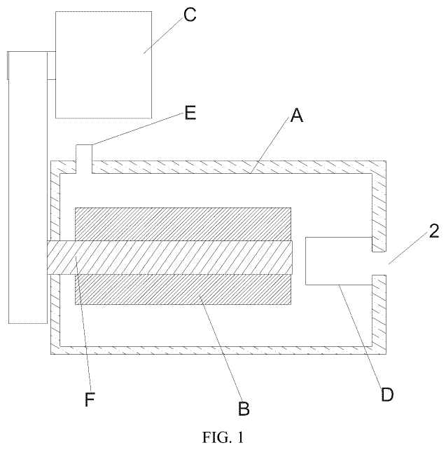

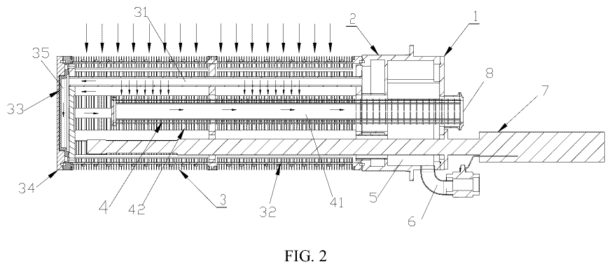

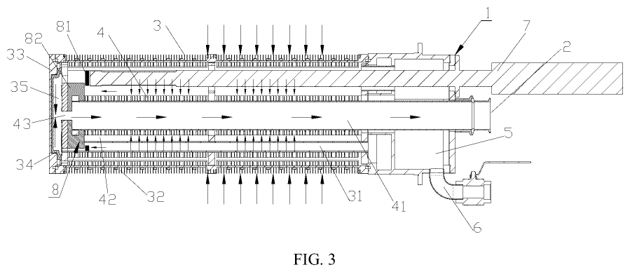

As shown in FIGS. 1-3, the present invention provides an embodiment of a agitating wet ball milling apparatus.

The agitating wet ball milling apparatus includes a grinding cylinder A and a dispersing mechanism B arranged in the grinding cylinder A; the dispersing mechanism B is connected to a driving assembly C via a rotating shaft F; the grinding cylinder A is provided with a feeding port E and a discharging port 2; the discharging port 2 is provided with a separation apparatus D. The separation apparatus D includes a first separator 3 provided with a cavity and a second separator 4 located in the cavity of the first separator 3; a first separation cavity 31 is disposed between the first separator 3 and the second separator 4; the second separator 4 is provided with a second separation cavity 41 in communication with a discharging port 2; the second separation cavity 41 is in communication with the first separation cavity 31 in a radial direction and in an axial direction, respectively to form a first separation channel and a second separation channel.

Specifically, the first separator 3 is provided with a cavity and a second separator 4 located in the cavity of the first separator 3. The cavity of the first separator 3 is partitioned by the second separator 4 to form the first separation cavity 31 for pre-separation and the second separation cavity 41 in communication with the discharging port 2; the first separation cavity 31 is located between the first separator 3 and the second separator 4. The second separation cavity 41 is located in the second separator 4; the second separation cavity 41 is in communication with the first separation cavity 31 in a radial direction and in an axial direction, respectively to form the first separation channel and the second separation channel. The first separator 3 and the second separator 4 are a hollow structure in a length direction, i.e., in an axial direction; the shape may be configured according to requirements. For the convenience of specification, the first separator 3 and the second separator 4 in this embodiment are a tubular structure, respectively. The first separator 3 and the second separator 4 are formed by overlaying a plurality of separation rings, and a gap is disposed between the separation rings. The first separator 3 and the second separator 4 may be also formed by winding metal wires having a cross section of a rectangle. Each coil of metal wire has a gap for separation, and the size of the gap may be configured according to the size of the mill ball for separating materials, being 0.12-0.18 mm to the minimum.

The first separator 3 and the second separator 4 are coaxially mounted on a separation fixed seat 1, where the second separation cavity of the second separator 4 is disposed through the separation fixed seat 1, and the second separation cavity 41 is in communication with the discharging port 2. The first separator 3 is provided with a first separation gap 32, and the second separator 4 is provided with a second separation gap 42.

A cover 33 for closing the cavity of the first separator in an axial direction and the first separation gap 32 in communication with an inside and an outside of the first separator 3 are disposed at an end portion and in a radial direction of the first separator 3, respectively; where a third separation gap 35 in communication with the first separation cavity 31 and the second separation cavity 41 is disposed between the cover 33 and an end portion of the second separator 4. A through hole 43 and a second separation gap 42 are disposed at the end portion and in a radial direction of the second separator 4, respectively; the second separation gap 42 is in communication with the second separation cavity 41, and the first separation cavity 31; the through hole 43 is in communication with the second separation cavity 41 and the first separation cavity 31 via the third separation gap 35. The first separation channel includes the first separation cavity 31 in communication with the first separation gap 32 and the second separation gap 42; that is, materials reach the first separation cavity 31 after passing through the first separation gap 32 from the outside of the first separator 3, and pass through the second separation gap 42 of the second separator 4 to reach the second separation cavity 41, and finally are discharged via the discharging port 2 in communication with the second separation cavity 41. The second separation channel includes the third separation gap 35 connected to the first separation gap 31 and the second separation gap 42; and the third separation gap 35 is in radial communication with the second separation cavity 41. That is, materials reach the first separation cavity 31 after passing through the first separation gap from the outside of the first separator 3, and move towards one end of the second separator 4 along a length direction, then through the third separation gap 35 between the second separator 4 and the first separator 3 as well as the through hole 43, and reach the second separation cavity 41, and finally are discharged via the discharging port 2 in communication with the second separation cavity 41.

The second separator 4 has a surface area of less than that of the first separator 3 such that pressure in the first separation cavity 31 increases during separation and the separation flow rate decreases to cause low separation efficiency. Moreover, the increase of pressure in the first separation cavity 31 easily results in a risk of separation failure of the second separator 4 under the action of pressure. A second separation channel is formed by one end of the second separation cavity 41, the third separation gap 35 in communication with the first separation cavity 31, and the through hole 43 in a radial direction, i.e., in a length direction, to increase the separation flow rate, which may reduce pressure in the first separation cavity. In the meantime, mass of the mill ball is much greater than the diameter and mass of materials during separation; even though a small number of mill balls enter the first separation cavity 31, these mill balls basically move to the bottom of the first separation cavity 31 due to own action of gravity; moreover, the second separation cavity 41 enable the mill balls to be far away from the discharging port 2, which also may block mill balls possibly existing in the first separation cavity 31 entering into the second separation cavity 41 to be discharged. Therefore, such a configuration may not only ensure the separation flow rate, but also may reduce the phenomenon of ball leakage.

In light of requirements, to block mill balls that enter the first separation cavity 31 entering into the second separation cavity 41 to be discharged from the discharging port 2, resulting in a phenomenon of ball leakage and contamination of the discharged materials, the second separation channel is provided with a ball tripping mechanism 8 which is preferably disposed at an end portion of the second separator 4. The ball tripping mechanism 8 includes a second interceptor 82 extending to the second separator 4 in a radial direction and a first interceptor 81 extending to the first separator 3 in a radial direction; and an interception channel is formed between the first interceptor 81 and the second interceptor 82 in a staggered manner, and the interception channel is in communication with the third separation gap 35. The cross section of the interception channel is an S-shaped structure; when slurry moves along the interception channel, mill balls with large mass or diameter may be blocked, thus avoiding that mill balls possibly entering the first separation cavity 31 enter the second separation cavity 41 via the through hole 43 to reach the discharging port after entering the third separation gap 35 to achieve the secondary separation of the mill balls.

According to the need, the first interceptor 81 is disposed on an end portion of the second separator 4, where the separation apparatus and the first interceptor 81 are disposed away from the discharging port 2 from far to near. That is, the first interceptor 81 is close to one side of the discharging port 2, and the second interceptor 82 is located outside the first interceptor 81. To disperse the possible blocking, a plurality of ball tripping mechanisms 8 may be configured along a length direction of the first separation cavity 31, which may avoid blocking to affect the flow and flow rate of slurry in the second separation channel, caused by the aggregation of the mill balls entering the first separation cavity when there is only one ball tripping mechanism.

To collect the separation apparatus entering the first separation cavity 31 better, a mill-ball sorting mechanism is further provided, and the mill-ball sorting mechanism includes a mill-ball sorting cavity 5 that is in communication with the first separation cavity 31 and is provided with a ball discharging hole (not shown in the drawings) and a switch 6 for controlling the ball discharging hole. To ensure that the mill balls entering the first separation cavity 31 may aggregate into the sorting cavity 5, the bottom of the mill-ball sorting cavity 5 is lower than the first separation cavity 31; the mill-ball sorting cavity 5 may be inclined to the direction of the discharging port 2. When there are more mill balls in the mill-ball sorting cavity 5, the switch 6 is turned on such that the mill balls are discharged via the ball discharging hole. The mill-ball sorting cavity 5 is disposed around the pipeline provided with the discharging port 2.

The end portion of the second separator 4 on the through hole 43 gradually increases in a radial direction, e.g., may be disposed in a trumpet-shaped structure. Such a configuration may not only increase the flow rate of the second separation channel, but also may block the mill balls entering the first separation cavity 31 from entering the second separation cavity 41.

According to the need, the first separation cavity 31 is internally provided with an ultrasonic vibration module 7; the ultrasonic vibration module 7 delivers energy to the slurry in the first separation cavity 31. Such a configuration, on the one hand, may reduce the aggregation of the separated ultrafine materials, and reduce blocking on the surface of the first separator 3 and the second separator 4. In addition, such a configuration further may endow energy to the mill balls entering the first separation cavity 31 to accelerate their deposition at the bottom of the first separation cavity or aggregation towards the mill-ball sorting cavity 5. The ultrasonic vibration module 7 may adopt the prior art, e.g., including a vibrating rod and an ultrasonic generator generating vibration towards the vibrating rod or around the vibrating rod.

According to the need, a sealing gasket 34 is disposed between the cover 33 and the first separator 3, to improve the leakproofness of the first separator 3 in a length direction.

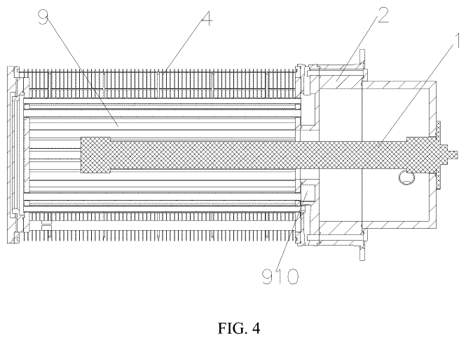

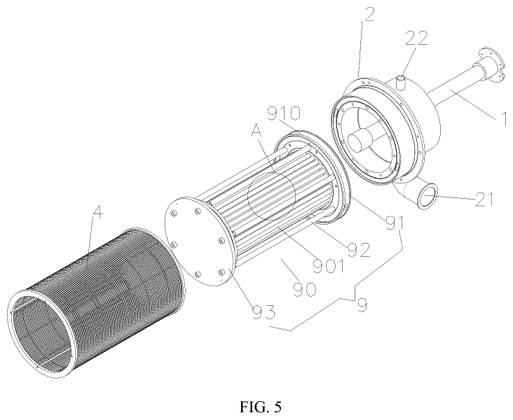

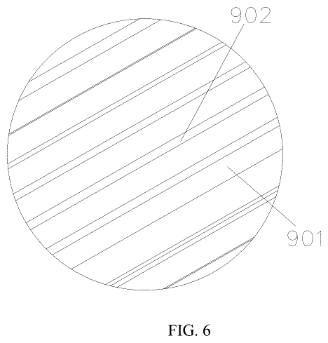

The generation of heat by the vibrating rod may be avoided due to operation. The present invention further provides another embodiment, as shown in FIGS. 4-6, the separation apparatus further includes a water-cooling mechanism for cooling; the water-cooling mechanism includes coolant tubes. Such a configuration, on the one hand, may reduce grinding to generate heat, and reduce the aggregation of superfine minerals; on the other hand, may reduce the operating temperature of the ultrasonic vibration module 7 to extend its service life.

The position of the water-cooling mechanism may be configured according to the need, e.g., may be configured in the first separator 3, and also may be sleeved with the ultrasonic vibration module 7.

The first separator 3 may be a mesh-screen separator or a separation-ring separator formed by overlapping separation rings, e.g., a mesh-screen separator is provided with a separation cavity in communication with a separation outlet. In this embodiment, a mesh-screen separator is set as an example; the ultrasonic generator and the water-cooling mechanism are disposed in the separation cavity of the first separator 3 for instruction.

The water-cooling mechanism 9 includes a coolant mechanism. The water-cooling mechanism includes a plurality of coolant tubes 901 to form a tubular cooling tube body 90; both ends of the cooling tube body 90 are connected to a first fixed plate 91 and a second fixed plate 93, respectively; the cooling tube body 90 is fixed between the first fixed plate 91 and the second fixed plate 93 via a fixed rod 92; the second fixed plate 93 is fixed with a flange 2; a water groove 910 in communication with the coolant tubes 901 is disposed on the first fixed plate 91 and the second fixed plate 93, respectively; a cooling separation gap 902 is disposed between two adjacent coolant tubes 901; and the flange 2 is provided with a water inlet 22 and a water outlet 21 that are in communication with the water groove 910. The number of the fixed rod 92 may be two or more, and distributed evenly if more.

To improve the cooling effect, the coolant tubes 901 are communicated in turn from end to end to achieve connection in series. In this way, cooling water entering via the water inlet 22 of the flange 2 flows through the water groove 910 such that the cooling water may flow through each of the coolant tubes 901, and then is discharged or circulated via the water outlet 21, thus ensuring the existence of running cooling water in each coolant tube 901.

According to the need, the coolant tubes 901 are arranged in parallel. The cross section of each coolant tube 901 is tabular such that a longer cooling separation gap 902 may be formed along a moving direction of materials to extend the contact time with materials, thus improving the heat dissipation efficiency.

The water inlet 22 and the water outlet 21 are located at the flange in a maximum position of a straight-line distance, which may ensure a maximum water-cooling path to improve heat dissipation efficiency.

A second embodiment may be further adopted to the water-cooling mechanism. The water-cooling mechanism includes a plurality of coolant tubes 901 to form a tubular cooling tube body 90; both ends of the cooling tube body 90 are connected to a first fixed plate 91 and a flange 2, respectively; the cooling tube body 90 is fixed between the first fixed plate 91 and the flange 2 via a fixed rod 92; the flange 2 is provided with a water groove (not shown in the drawings) in communication with the coolant tubes 901; the water groove is in communication with a water inlet 22 and a water outlet 21 on the flange 2. The first fixed plate 91 is further provided with another water groove (not shown in the drawings) in communication with the coolant tubes 901; a cooling separation gap 902 is disposed between two adjacent coolant tubes 901, where flange 2 is provided with a water inlet 22 and a water outlet 21 in communication with the water groove or hole.

According to the need, a third embodiment may be further adopted to the water-cooling mechanism. On the basis of the second embodiment, no first fixed plate is disposed in the water-cooling mechanism. Specifically, the water-cooling mechanism includes a plurality of coolant tubes to form a tubular cooling tube body 90; the coolant tubes 901 adjacent to one end of the tubular cooling tube body 90 are in spaced communication with each other, another end thereof is fixed with a flange 2; the flange is provided with a water groove (not shown in the drawings) in communication with the adjacent coolant tubes; during cooling, cooling water enters from the water inlet 22, and flows through each of the coolant tubes 901 to reach the water outlet 21 to be discharged. A cooling separation gap 902 is disposed between two adjacent coolant tubes 901.

According to the need, one end of the coolant tubes 901 located at the same side in the above embodiment may be communicated, and the water inlet 22 on the flange 2 is in communication with one coolant tube 901, and the water outlet 21 is also in communication with another coolant tube 901 only, and other coolant tubes 901 at the side of the flange 2 are communicated with each other. Such a configuration may ensure that coolant also may reach each of the coolant tubes 901.

According to the need, a fourth embodiment may be further adopted to the water-cooling mechanism. The water-cooling mechanism includes formation of a water loop made of a coolant tube 901; the coolant tube 901 is bent into a W shape, wave or impulse wave shape, to form the tubular structure in the above embodiment. Both ends of the coolant tube 901 are fixed with a flange 2, respectively; the flange 2 is provided with a water inlet 22 and a water outlet that are in communication with the coolant tube. A water-cooling circuit may be also formed in a flow direction in use.

According to the need, the coolant tube 901 may be also configured into a spiral structure (not shown in the drawings). A cooling separation gap is disposed between adjacent spirals; both ends of the coolant tube 901 are in communication with the water inlet and the water outlet of the flange. According to the need, the water-cooling mechanism may be also disposed between the ultrasonic generator 1 and the separator 4.

To achieve the control of the ultrasonic generator 1, the ultrasound field separation apparatus further includes a controller (not shown in the drawings) for controlling the ultrasonic generator to work. The controller may consist of a singlechip and its peripheral circuit.

The ultrasonic generator 1 includes a rodlike ultrasonic generator and other components or apparatuses capable of generating an ultrasound field.

In use procedure, the ultrasonic generator generates an ultrasound field within the separator; when power of the ultrasonic generator is large, the ultrasound field may extend to the outside the separator, to separate the grinding materials on or around the separator from a medium. Such a configuration may avoid blocking the separator to improve smooth discharging, and may further provide composite kinetic energy for the grinding medium to improve the grinding efficiency. In the meantime, grinding materials with small diameter easily aggregate together; the ultrasound field generated by the ultrasonic generator may disperse the grinding materials outside the separator and the grinding medium, and also may disperse the separated grinding materials, i.e., the grinding materials in the separator, thus avoiding the subsequent secondary dispersion. Meanwhile, the ultrasonic generator will release certain heat during operation. The water-cooling mechanism effectively reduces the operating temperature of the ultrasonic generator to improve the reliability of continuous working, which also may avoid the aggregation of materials with small diameter due to heat. In the meantime, due to the cavitation effect of ultrasonic wave in a liquid grinding medium, an explosion action may be formed on the surface of particles, which may quicken the nanocrystallization of the material particles outside the separator. Moreover, the ultrasonic generator may be further disposed inside the separation cavity of the separator; hence, such a configuration may further achieve dispersion and secondary grinding of the materials separated in the separation cavity. Furthermore, such a configuration may further avoid a blocking phenomenon formed on the surface of the separator.

The above embodiments are merely for illustrative of the technical solution of the present invention, but are not construed as limiting the present invention. Even though the present invention is described in detail with reference to the preceding embodiments, those skilled in the art should understand as follows: the technical solution recited in the preceding each embodiment may be still amended, or partial technical features therein are equivalently replaced. Moreover, those amendments, or replacements will not enable the essence of the corresponding technical solution to depart from the spirit and scope of the technical solution in each embodiment of the present invention.

What is claimed is:

1. A agitating wet ball milling apparatus, comprising a separation apparatus, wherein the separation apparatus comprises a first separator provided with a cavity and a second separator located in the cavity of the first separator; a first separation cavity is disposed between the first separator and the second separator; the second separator is provided with a second separation cavity in communication with a discharging port; the second separation cavity is in communication with the first separation cavity in a radial direction and in an axial direction, respectively to form a first separation channel and a second separation channel; a cover for closing the cavity of the first separator in an axial direction and a first separation gap in communication with inside and outside of the first separator are disposed at an end portion and in a radial direction of the first separator, respectively; a third separation gap in communication with the first separation cavity and the second separation cavity is disposed between the cover and an end portion of the second separator; a through hole and a second separation gap are disposed at the end portion and in a radial direction of the second separator, respectively; the second separation gap is in communication with the second separation cavity and the first separation cavity; the through hole is in communication with the second separation cavity and the first separation cavity via the third separation gap; the second separation channel comprises the third separation gap in communication with the first separation gap and the second separation cavity; and the third separation gap is in axial communication with the second separation cavity.

2. The agitating wet ball milling apparatus according to claim 1, wherein the first separation channel comprises the second separation cavity in radial communication with the first separation gap and the second separation gap.

3. The agitating wet ball milling apparatus according to claim 1, wherein the second separation channel comprises the third separation gap connected to the first separation gap and the second separation gap, and the third separation gap is in radial communication with the second separation cavity.

4. The agitating wet ball milling apparatus according to claim 3, wherein the second separation channel is provided with a ball tripping mechanism.

5. The agitating wet ball milling apparatus according to claim 4, wherein the ball tripping mechanism comprises a second interceptor extending to the second separator in a radial direction and a first interceptor extending to the first separator in a radial direction; and an interception channel is formed between the first interceptor and the second interceptor in a staggered manner.

6. The agitating wet ball milling apparatus according to claim 1, wherein the first interceptor is close to one side of the discharging port, and the second interceptor is located outside the first interceptor.

7. The agitating wet ball milling apparatus according to claim 1, wherein the separation apparatus is further provided with a mill-ball sorting mechanism.

8. The agitating wet ball milling apparatus according to claim 7, wherein the mill-ball sorting mechanism comprises a mill-ball sorting cavity that is in communication with the first separation cavity and is provided with a ball discharging hole and a switch for controlling the ball discharging hole, and a bottom of the mill-ball sorting cavity is lower than the first separation cavity.

9. The agitating wet ball milling apparatus according to claim 8, wherein the bottom of the mill-ball sorting cavity is inclined to a direction of the discharging port.

10. The agitating wet ball milling apparatus according to claim 1, wherein the first separation cavity is internally provided with an ultrasonic vibration module.

11. The agitating wet ball milling apparatus according to claim 10, wherein the ultrasonic vibration module comprises a vibrating rod and an ultrasonic generator generating vibration towards the vibrating rod or around the vibrating rod.

12. The agitating wet ball milling apparatus according to claim 11, wherein the separation apparatus further comprises a water-cooling mechanism for cooling the ultrasonic vibration module; the water-cooling mechanism comprises a plurality of coolant tubes to form a tubular cooling tube body; both ends of the cooling tube body are connected to a first fixed plate and a second fixed plate, respectively; the cooling tube body is fixed between the first fixed plate and the second fixed plate via a fixed rod; the second fixed plate is fixed with a flange; a water groove in communication with the coolant tubes is disposed on the first fixed plate and the second fixed plate, respectively; a cooling separation gap is disposed between two adjacent coolant tubes; and the flange is provided with a water inlet and a water outlet that are in communication with the water groove.

13. The agitating wet ball milling apparatus according to claim 12, wherein the cooling separation gap is greater than the separation gap on the second separator.
